(19) United States
(12) Patent Application Publication
(10) Pub. No.: US 2003/0145305 A1
(43) Pub. Date: Jul. 31, 2003

(54) Method for developing and managing large-scale web user interfaces (WUI) and computing system for said WUI

(76) Inventor: Mario Ruggier, Segny (FR)

Correspondence Address: Finnegan, Henderson, Farabow,, Garrett & Dunner, L.L.P., 1300 I Street, N.W., Washington, DC, 20005-3315, US

(21) Appl. No.: 10/292,927

(22) Filed: Nov. 13, 2002

Related U.S. Application Data
(60) Provisional application No. 60/331,453, filed on Nov. 16, 2001.

(51) Int. Cl. G06F 9/44

(52) U.S. Cl. 717/100

(57) ABSTRACT

A method for developing and managing large-scale web user interfaces (WUI), comprising: designing and implementing the WUI using the Model View Controller (MVC) paradigm, and adding an additional layer (5) to the MVC paradigm, said additional layer (5) comprising a UI description (1), said UI description comprising all UI elements that are used by at least one of the MVC implementation components, such as views and the sub-elements used to define them, descriptions of content data, and the behavior of the WUI.

The present invention relates to a method for developing and managing large-scale web user interfaces (WUI), and a computing system for a large scale WUI developed according to said method, in accordance with the precharacterising part of the accompanying main claims.

In the present context the term large-scale WUI should be understood as an WUI comprising at least 100 of screens.

The present invention relates to a large scale WUI designed and implemented using the widely accepted Model-View-Controller (MVC) paradigm, which identifies an Interface application as being composed of three distinct components, namely Views (screens), Controller (event handler), and the Model (underlying application).

Separation of these three components is loosely equivalent to separation of presentation (Views), logic (Controller) and content (data exchange with the Model), and has many recognized advantages.

The type of Web User Interfaces for which this invention is most applicable are those that are required to interface to systems that employ an extensive Data Model or Data Models, and which invariably need to be either mapped to corresponding Data Models more appropriate for usage by the User Interface, or which need the addition of information specific to the User Interface, such as language-dependent labels (e.g. French, German), or usage-dependent interaction information for a data variable (i.e. how the data variable is to be shown in the User Interface, for example as a text field or string, or as a checkbox list, or as an image, and so on). This invention is also applicable for User Interfaces that may require customisations from one deployment scenario to another.

With the exception of small Web User Interfaces, composed of a single or very few screens, a Web User Interface is generally considered to be just one layer of a 3-tier application:

Presentation Layer⇄Application Layer⇄Persistence (Data) Layer

The Presentation Layer (or Web User Interface) is an application in its own right, with its own components, such as the screens or web pages and presentation information, the Control logic (the behavior of the User Interface), and the messages between the User Interface Layer and the Application (Model) Layer.

Various approaches may be employed for implementing Web Graphic User Interfaces (GUI). Smaller GUIs tend to employ what is known as the Model 1 (page-centric) approach:

Request A→Request Handler A (server program)→Web Page 1

Request B→Request Handler B (server program)→Web Page 2

Larger GUIs adopt the more scalable Model 2 (servlet-centric) approach:

Request A→Mediating Server Program+Appropriate Handlers→Web Page 1

Request B→Mediating Server Program+Appropriate Handlers→Web Page 2

The big difference between the two approaches is that, in Model 2, the input data (from the client web browser) and the behavior (the page flow) is processed and controlled centrally by a single Mediating Server Program, plus (if needed) the use of specialized handlers that implement functionality needed to build the specific response. In Model 2, the Mediating Server Program also selects which Web Page to send as response to each request, while in Model 1 this information is coded into each Request handler.

Neither Model 1 nor Model 2 address the issue of how each Web Page is created or maintained.

For a discussion of Model 2 implementation architecture (for the Java environment) see:

http://www.javaworld.com/javaworld/jw-12-1999/jw-12-ssj-jspmvc.html

More generally, Model 2 implementations emulate the Model-View-Controller, or MVC, architecture, which is a widely accepted technology-independent approach for developing User Interfaces for dynamic systems, irrespective of whether they are web-based or not. The MVC paradigm emerged from Smalltalk-80 application development practices, but has been recognized and adopted as a generic approach for the development of user applications.

The essence of MVC is:

I. The Controller (a server program) processes input events (in web applications, these are HTTP requests).

II. The Controller determines, using the input event data as well as results from messages to the underlying Application Layer, what the next state of the UI should be (e.g. what is the next view).

III. The Controller invokes the appropriate view, which displays the required output (in web applications this is a web page returned as the HTTP response).

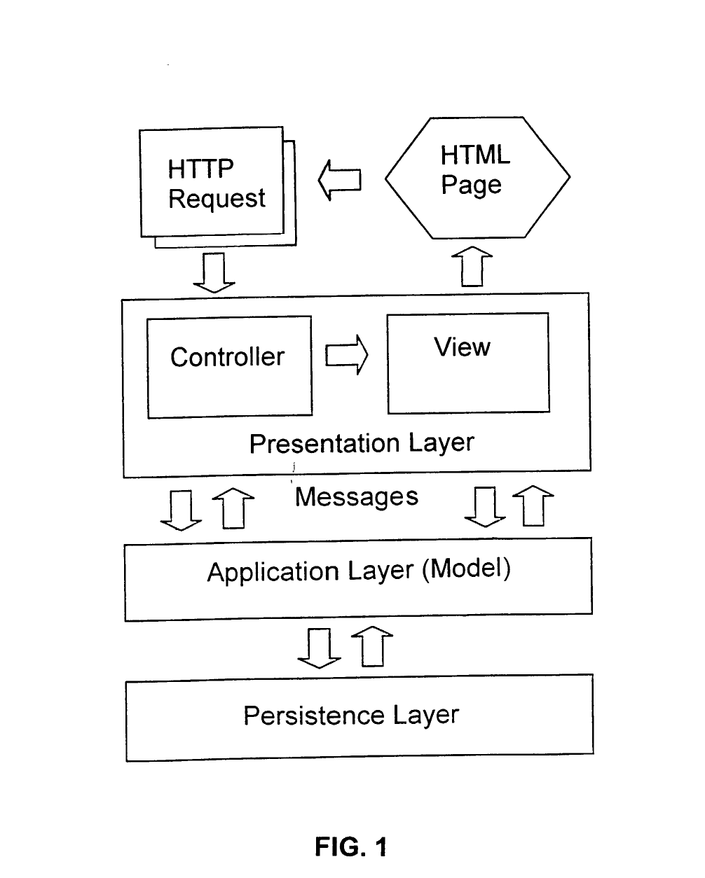

The diagram of FIG. 1 shows the interaction between a web client, the Presentation Layer, and the Application Layer, in a Model-View-Controller architecture.

For the scope of this discussion, it suffices to say that the generic MVC approach is the most widely recommended approach for developing large (100's of screens) web user interfaces, irrespective of the implementing technologies chosen.

For a more detailed discussion of the MVC architecture as applied to web applications, see: http://www.uidesign.net/1999/papers/webmvc_part 1.html

Struts (a project of the Apache Software Foundation) is an interesting framework that supports the MVC architecture for Web User Interface applications developed in Java:

http://www-106.ibm.com/developerworks/library/j-struts/?n-j-2151

Barracuda is an open source presentation framework that supports MVC and designed to make it easier to build web applications in Java using XMLC, DOM and Servlet 2.2 technologies.

http://barracuda.enhydra.org/cvs_source/Barracuda/docs/vision.html

HTML is the base language in which web pages are coded. However, HTML as a language has no concept of variables or content templates. Furthermore, HTML forms use input field names to associate an input field with user-supplied data. When a form is submitted via HTTP to a handler application on a web server, the form data is transmitted as a flat list of name/value pairs.

Thus, HTML presents some serious limitations for it to be used for implementing a User Interface. Namely:

I. The mapping of each field name (flat list) to typically a hierarchical application data model must be handled by the User Interface logic, usually on a per-page basis.

II. Given the lack of variables and content templates in HTML, User Interface views that must display dynamic data must necessarily be implemented using a mix of technologies, namely:

the presentation (typically HTML, plus optionally CSS, JavaScript or other client-side presentation technologies) and

scripting (typically server-side) to relate the dynamic data with the presentation. In the worst cases this is mixed into the behavior logic of the User Interface, reducing maintainability. User Interface behavior logic may be kept separate from code that relates dynamic data to the presentation by using a templating mechanism, such as ASP (primarily for VBScript), JSP, XMLC, WebMacro (for Java), as well as several others for other programming languages such as Perl and Python. (Note that technologies such as ASP and JSP are not strictly speaking templating mechanisms, but, with some discipline, may be used as such).

The task of creating and maintaining the presentational aspects of the (potentially hundreds of) dynamic web pages that make up a User Interface is typically addressed in various ways:

creating and maintaining the web pages one by one, possibly with the help of off-the-shelf authoring tools.

creating the pages one by one, with as much factoring out of repeated code as possible, thus achieving some reduction of the required per-page maintenance. Features of authoring tools could be leveraged also here, but a substantial amount of presentational code would still end up being copy-pasted across the User Interface.

Furthermore, the increased importance of striking visual designs for web-based User Interfaces aggravates this problem. Added to this, the available technology to implement the stylized web interface widgets (e.g. DHTML) is trickier to work with than with traditional interface widget toolkits (e.g. Java Swing). The presentation code therefore only gets more complicated, and, being not only a User Interface but also a web site, style and presentation modifications are all the more frequently needed or demanded. The time and effort to update or modify a web-based User Interface consistently is substantial, being particularly difficult if maintenance is on a per-page basis.

In view of what is stated above the need of powerful tools to globally manage the presentation is a major issue for a large scale WUI development.

Another problem is due to the nature of MVC: While MVC is a good approach to help separate interface logic (Controller), presentation (Views), and data exchange with the underlying application (Model), it offers no advantages to help address the above mentioned problems. In fact, an essential limitation of MVC is that, although conceptually Views, Controller and Model are independent from each other, they are implicitly tied together. These implicit dependencies must be kept in synchrony by the respective developers of each of the three MVC components. The MVC paradigm, in and of itself, cannot help automate the management of these dependencies; only tools that support MVC may do this.

Examples of implicit interdependencies include:

The Controller must send messages to the underlying Application, with user input data coming from the HTTP request. Thus, the Controller must know about what messages the underlying Application can handle, and how to map each user input data value to the data model used to construct the messages to be sent to the underlying Application.

Views must both collect data from the web users to pass it on to the Controller, as well as receive data from the Controller and present it to the user. This requires that each piece of data exchanged between Views and the Controller is necessarily associated with human presentational information, such as how a given property is to be presented in different contexts, language dependent labels and descriptions to aid and orient the user.

The MVC paradigm itself, and the various MVC frameworks in existence, do not necessarily help in the minimization of the effort required to deal with the implicit dependencies between the three implementation components.

Scope of this invention is to realize a method for developing and managing large-scale web user interfaces (WUI), and a computing system for a large scale WUI developed according to said method, which can be used to describe, in a concise, logical, and humanly readable fashion, said User Interface.

A further object is to develop a method that serves as reference developer documentation, with the additional valuable characteristic that this documentation is by definition always up to date with the implementation, as it is exactly this same description that is processed programmatically for the deployment of the User Interface.

A further object is to develop a method and a system to relate descriptions of properties of the Application Data Model with additional information required by the User Interface, such as human labels and descriptions for a given property and how a given property is to be handled presentationally.

A further object is to develop a method and a system which guaranty consistency between data sets and the presentation of the data.

A further object is to develop a method and a system comprising logical abstractions of presentational elements, typically complex and fragile DHTML implementations of special interface widgets, spatial containers, data representations and effects, thus improving the maintainability of these presentational aspects, as well as the consistency of the User Interface.

A further object is to develop a method and a system which define re-usable and parametrized presentational elements.

A further object is to develop a method and a system which improves re-usability and maintainability of User Interface elements.

A further object is to develop a method and a system comprising a flexible framework to manage presentational elements, that minimizes the management overhead.

A further object is to develop a method and a system comprising an infrastructure to facilitate the automatic generation of Web Page Templates for target delivery media, e.g. HTML based web browsers.

A further object is to develop a method and a system with a reduced impact on the runtime Controller code when the User Interface is modified or re-organised.

A further object is to develop a method and a system with a minimum overhead when a customisation of a User Interface is needed.

A further object is to develop a method and a system which does not require wading through User Interface logic code to understand the User Interface flow.

A further object is to develop a method and a system with an automatic data validation, which takes into account constraints imposed by the Views and constraints imposed by the Underlying Application.

A further object is to develop a method and a system comprising a technique to automate the bi-directional mapping of data between the User Interface and the Underlying Application.

A further object is to develop a method and a system comprising a framework permitting the implementation of a generic User Interface Runtime Controller, with a minimized need for custom Runtime handlers.

A further object is to develop a method and a system which is platform and technology independent (except for XML technologies, which are themselves platform and vendor independent).

These and further objects which will be apparent to an expert of the art, are attained by a method and a system according to the characterizing portion of the accompanying claims.

The present invention will be more apparent from the accompanying drawings provided by way of non-limiting example, which schematically represent:

FIG. 1 shows the interaction between a web client, the Presentation Layer, and the Application Layer, in a known Model-View-Controller architecture,

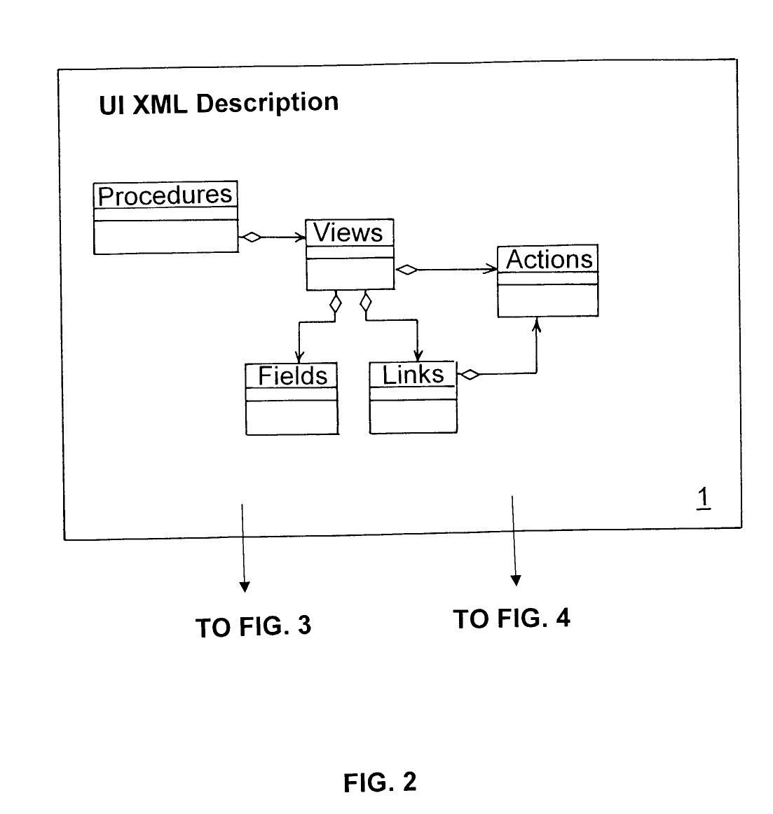

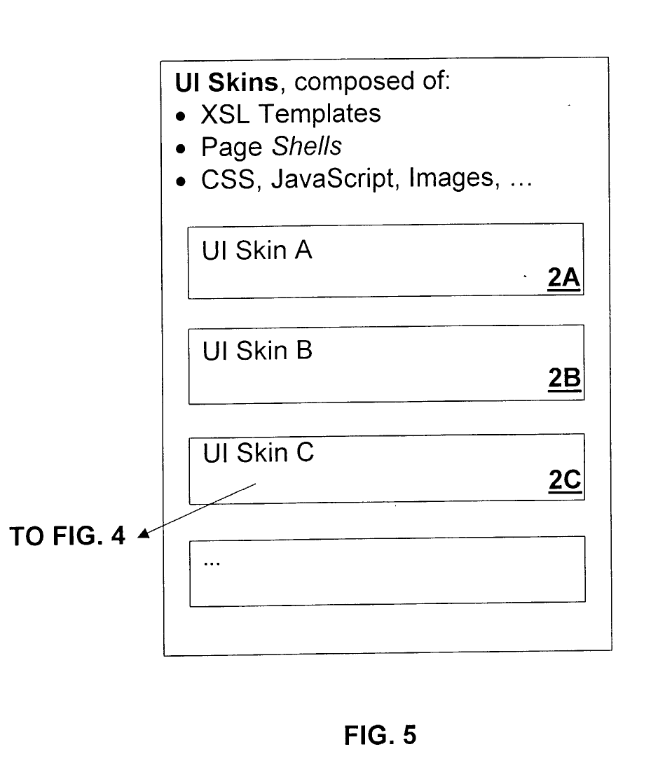

FIGS. 2-6 show the major components of a MVC architecture according to the method and system of the present invention; and how these components relate to each other,

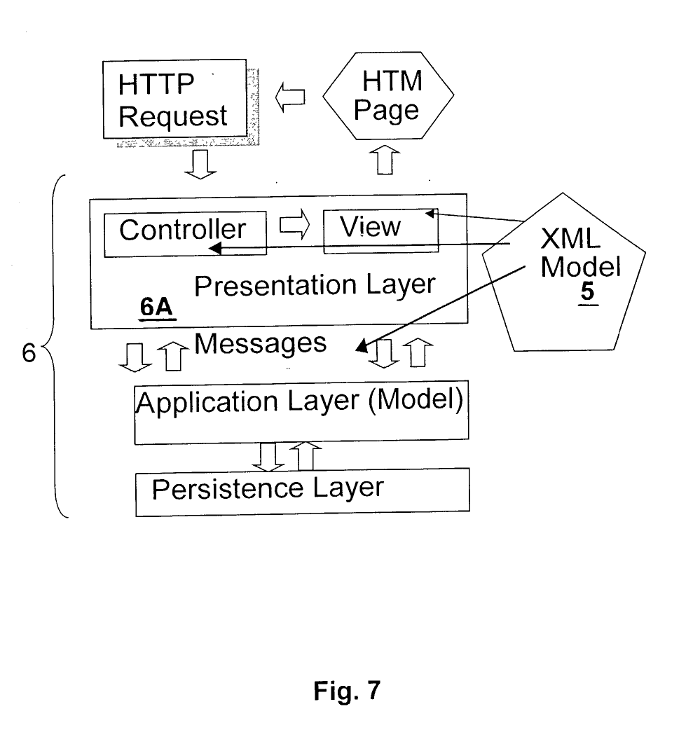

FIG. 7 shows the new model-driven architecture for the Presentation Layer according to the invention and how the XML Description of a User Interface imposes and builds on the MVC Presentation Layer of a 3-tier web application,

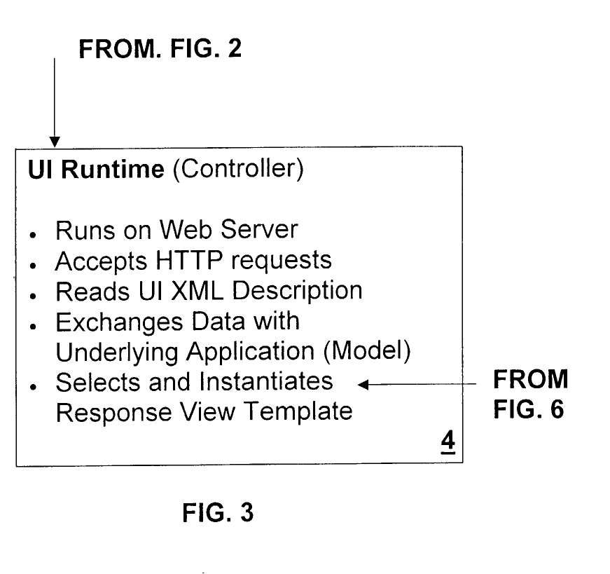

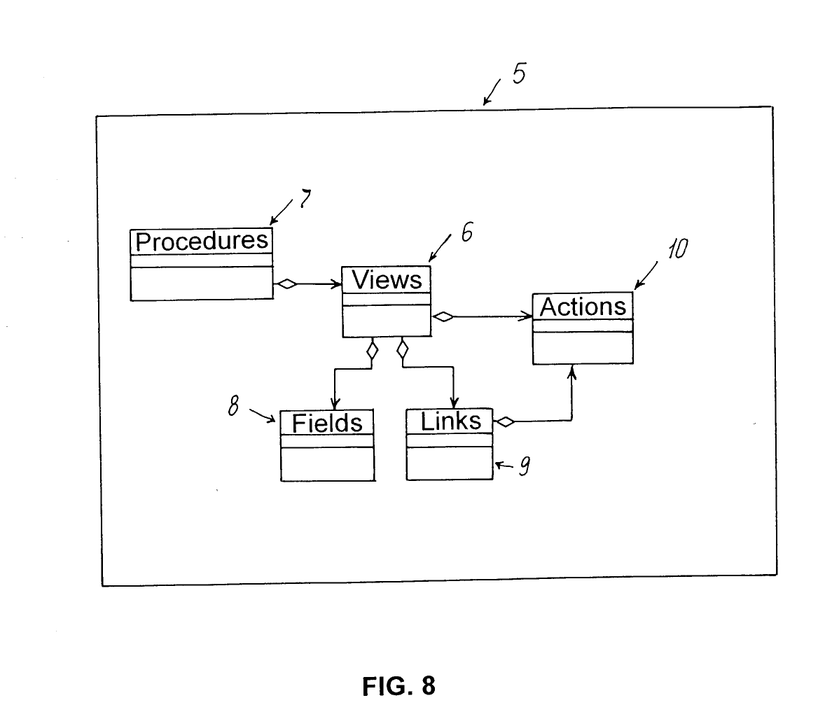

FIG. 8 shows a high-level view of the XML Model of FIG. 3,

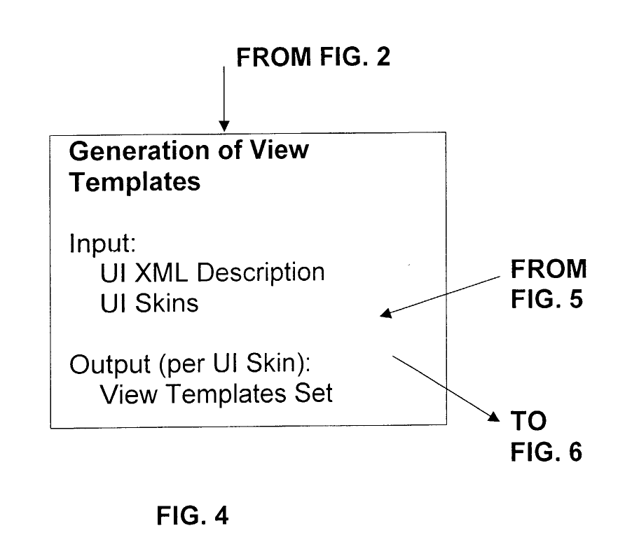

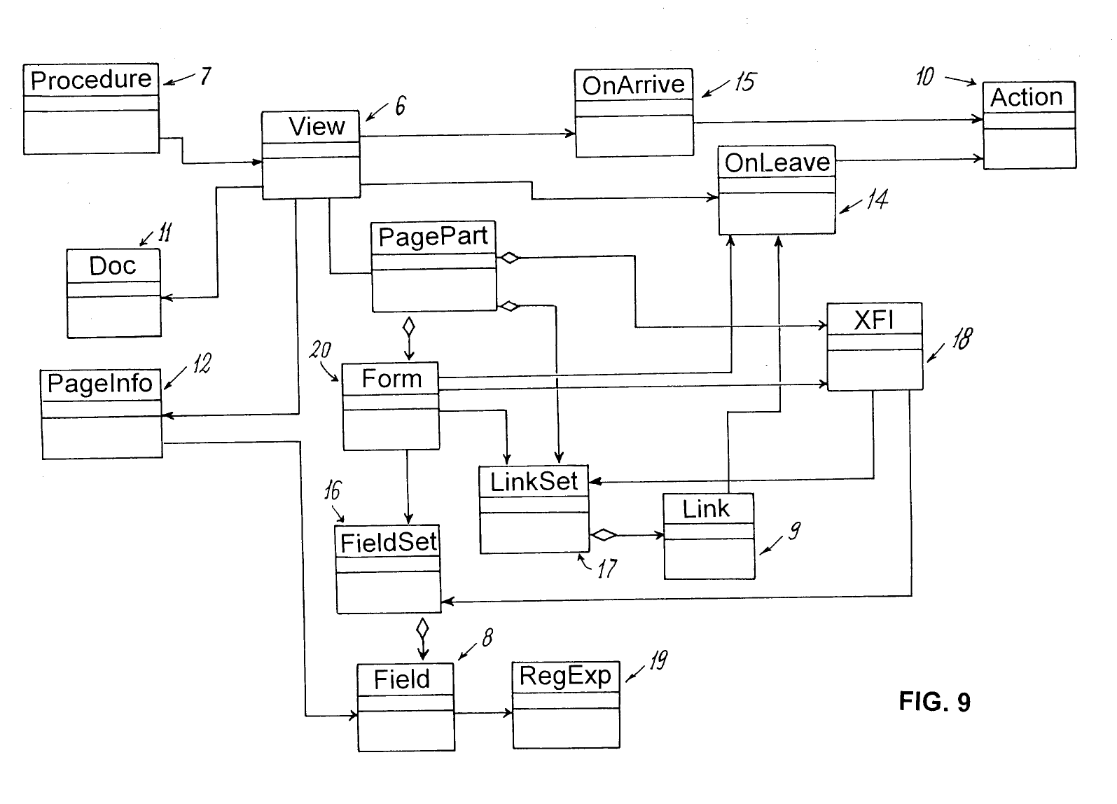

FIG. 9 shows the XML Elements of the Model of FIG. 4, seen as an object model diagram,

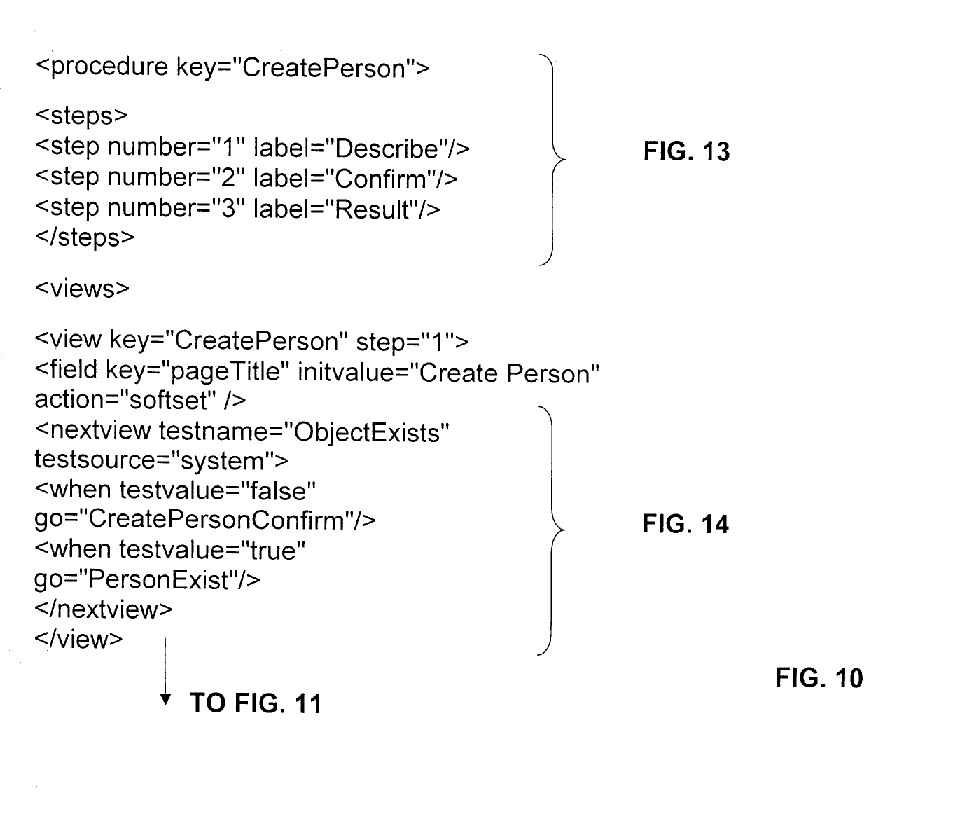

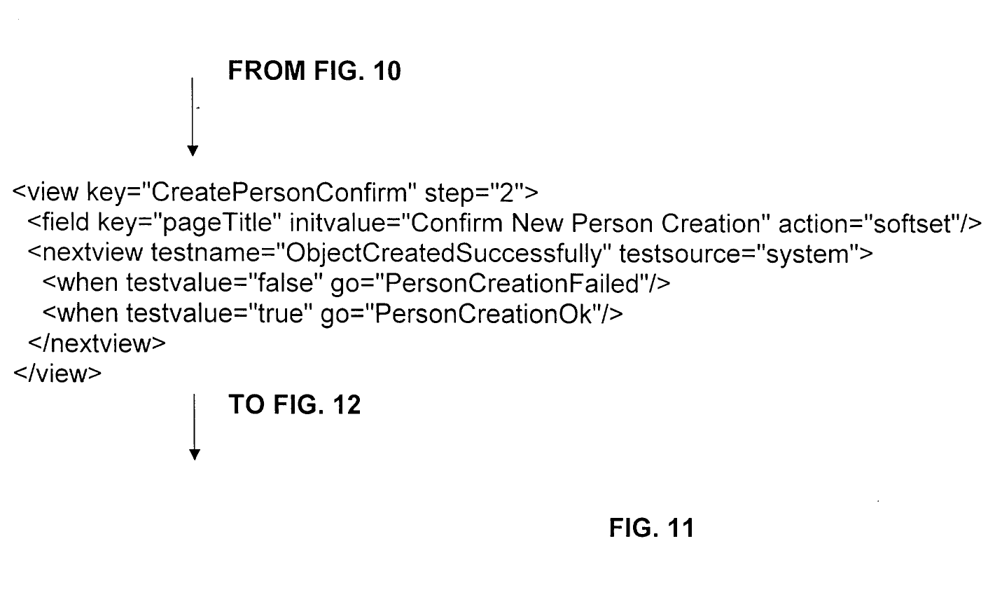

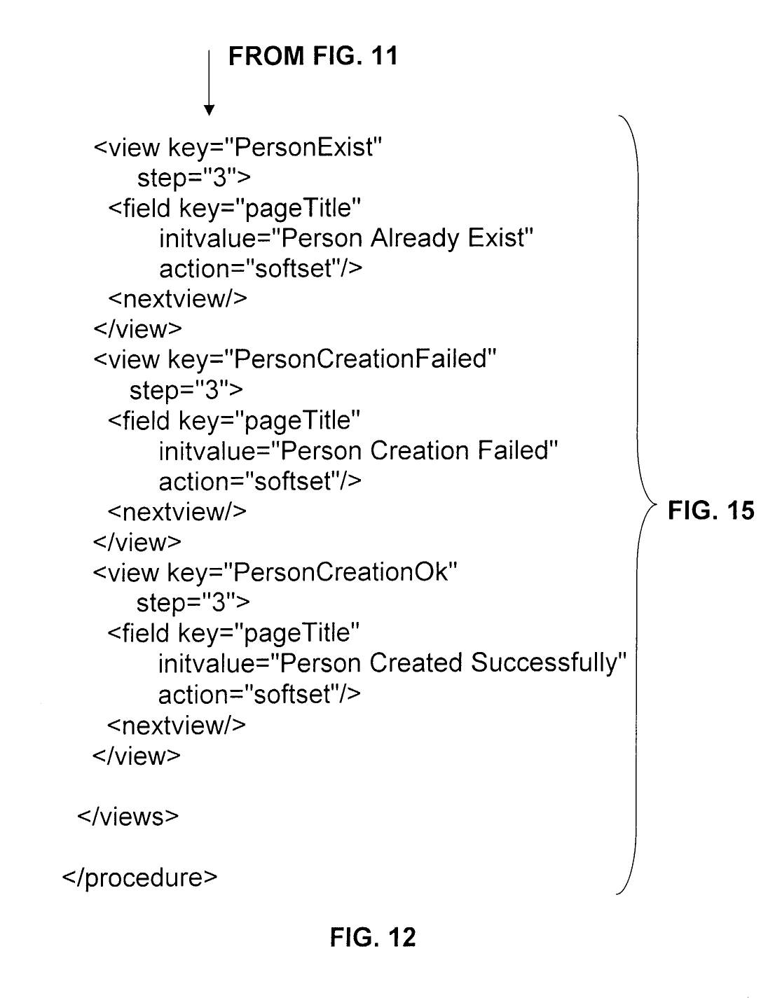

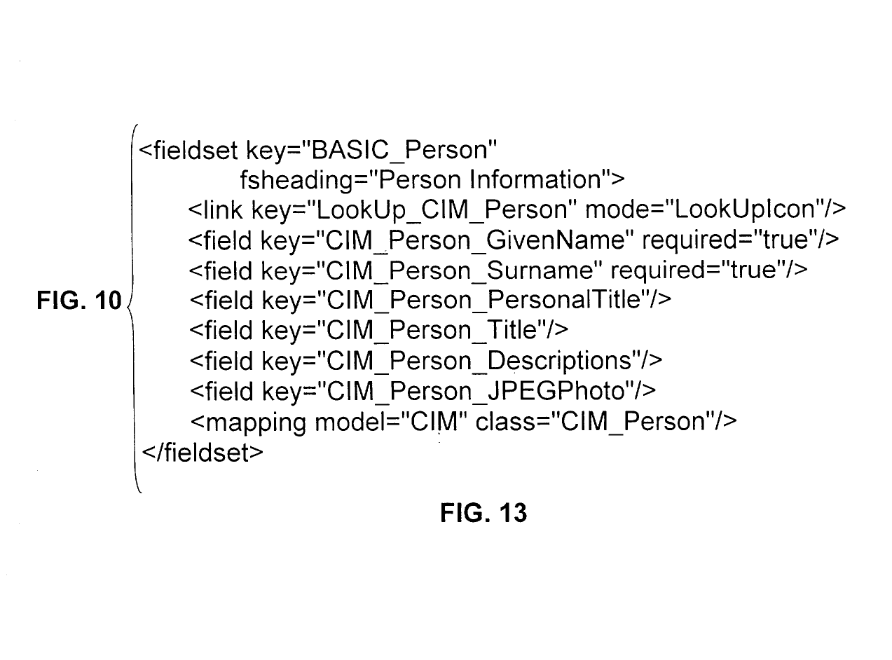

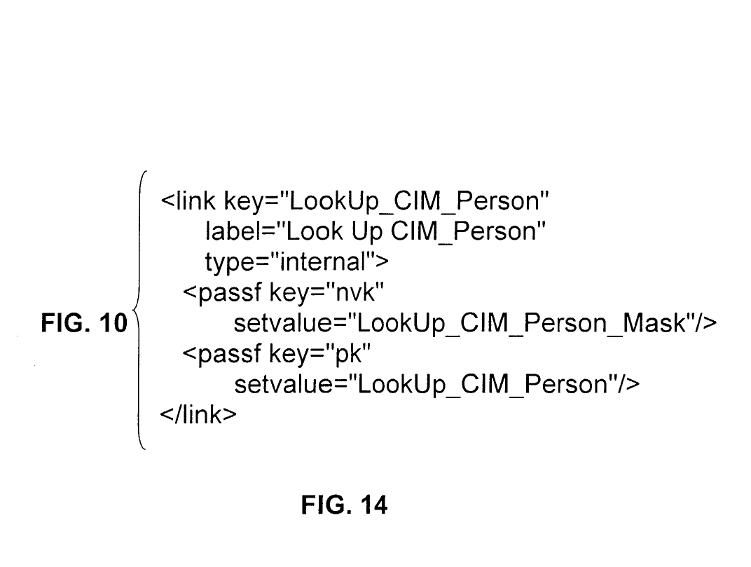

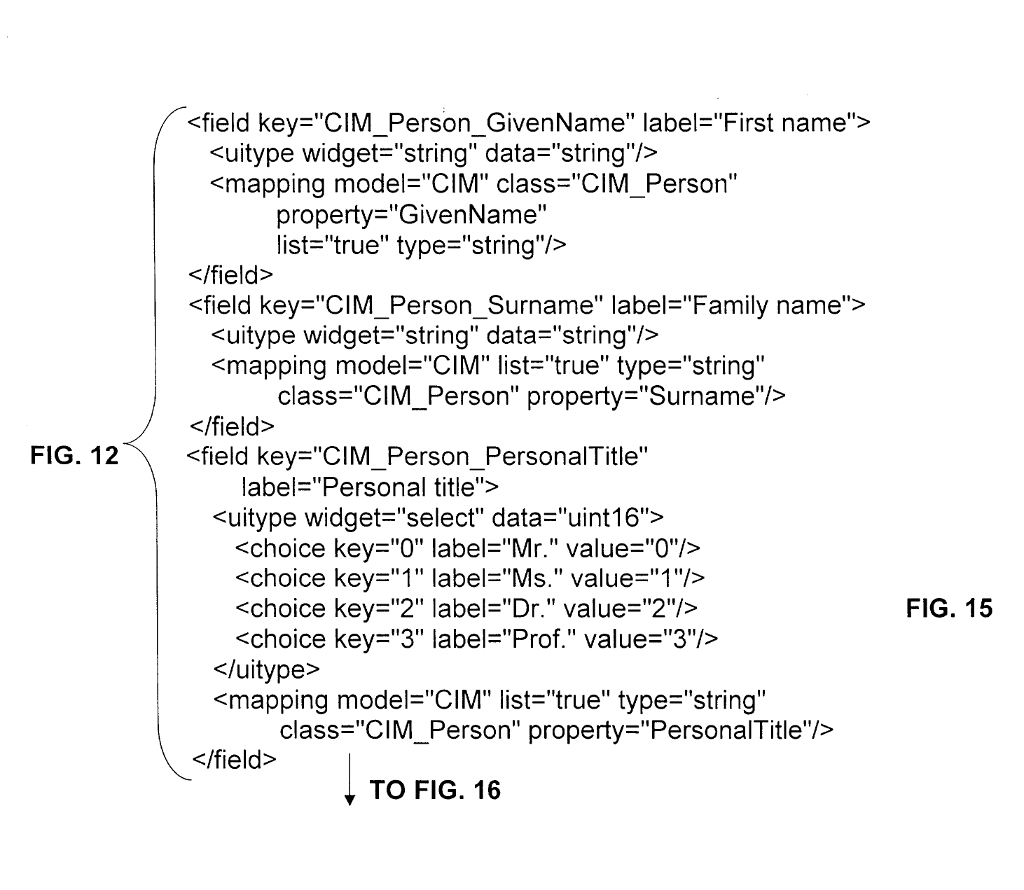

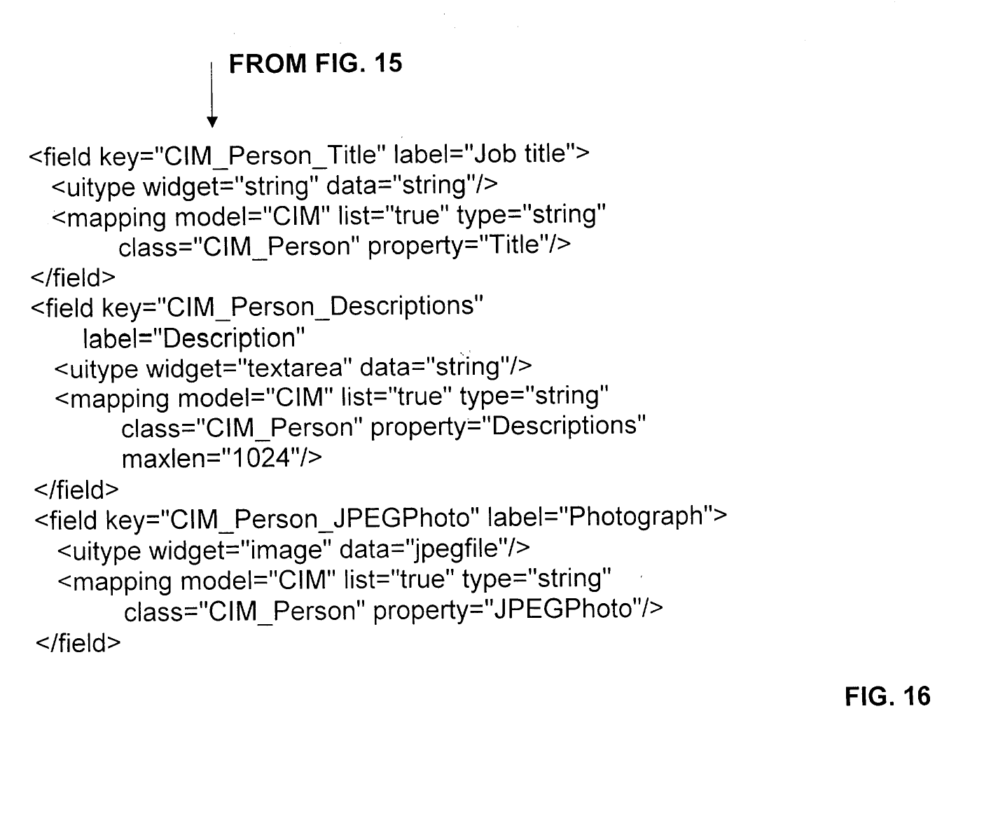

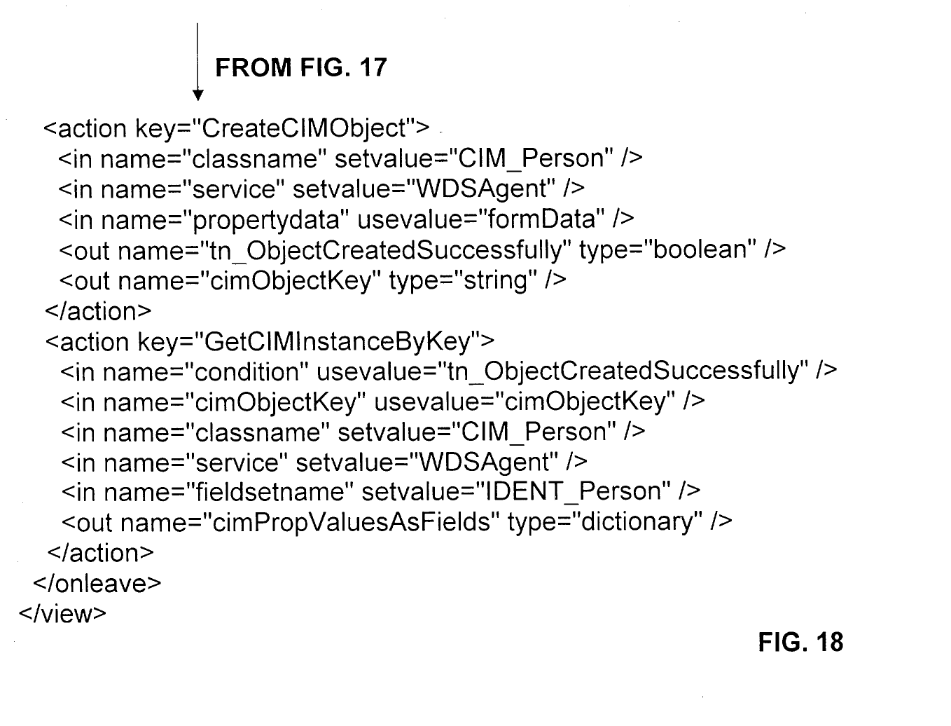

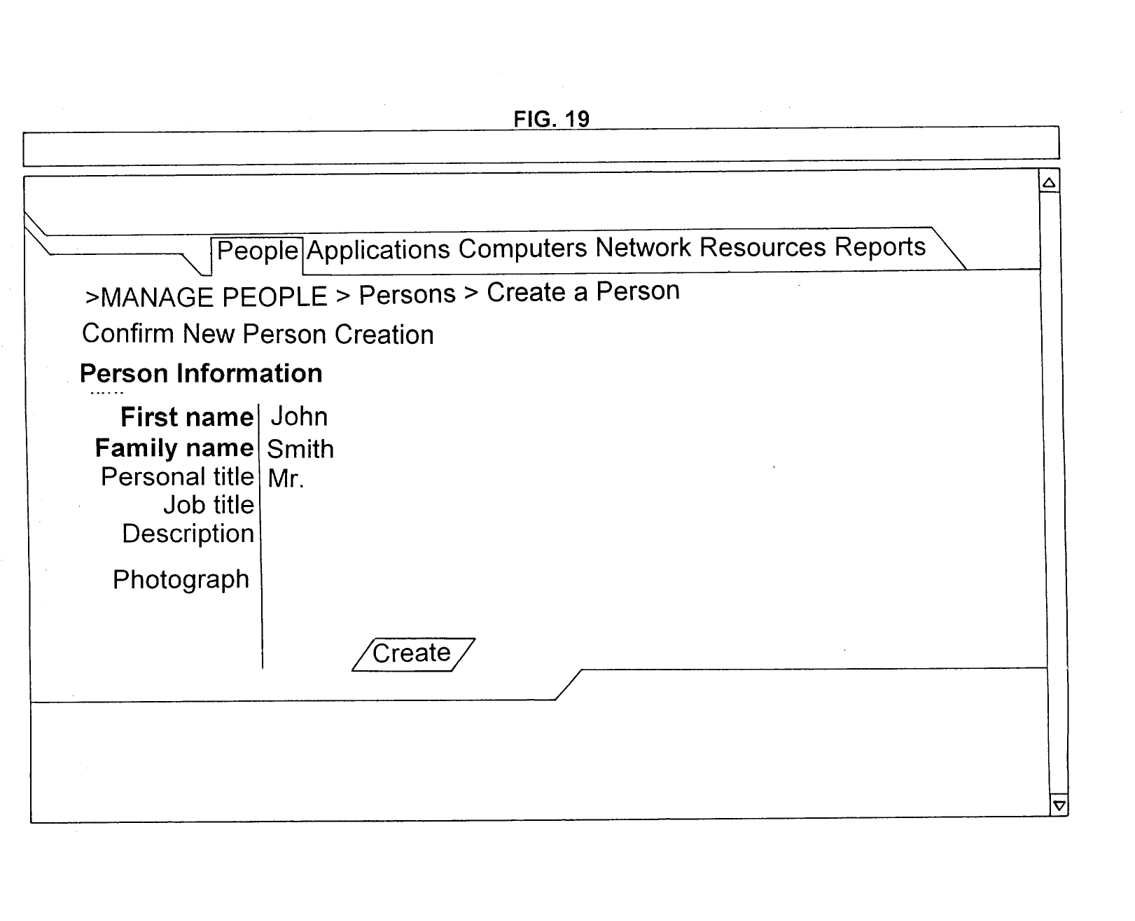

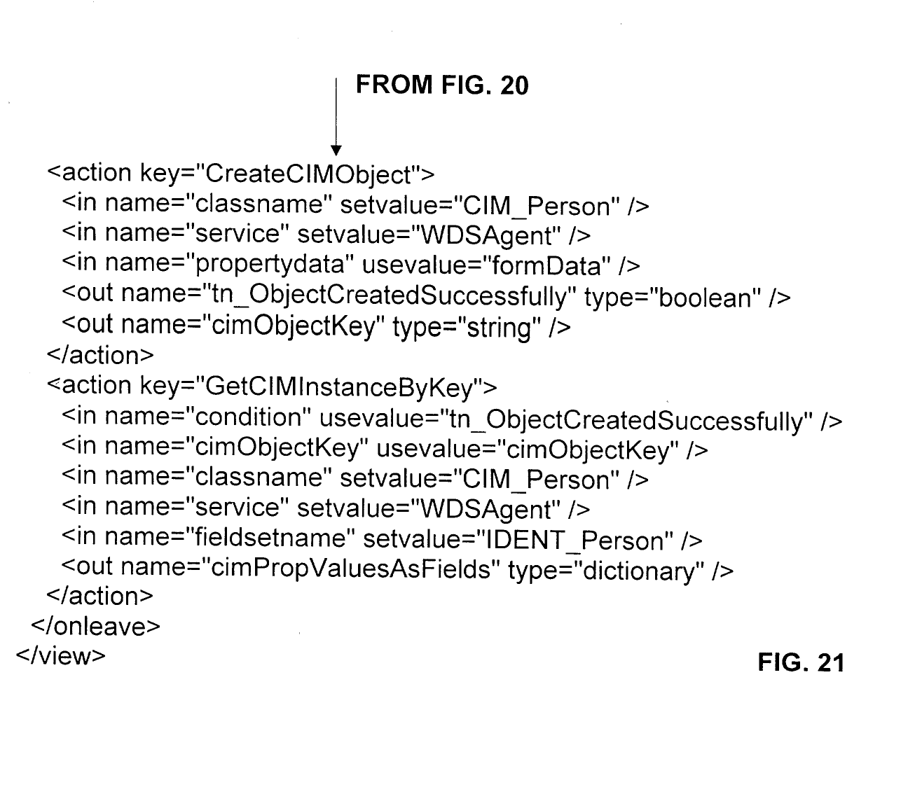

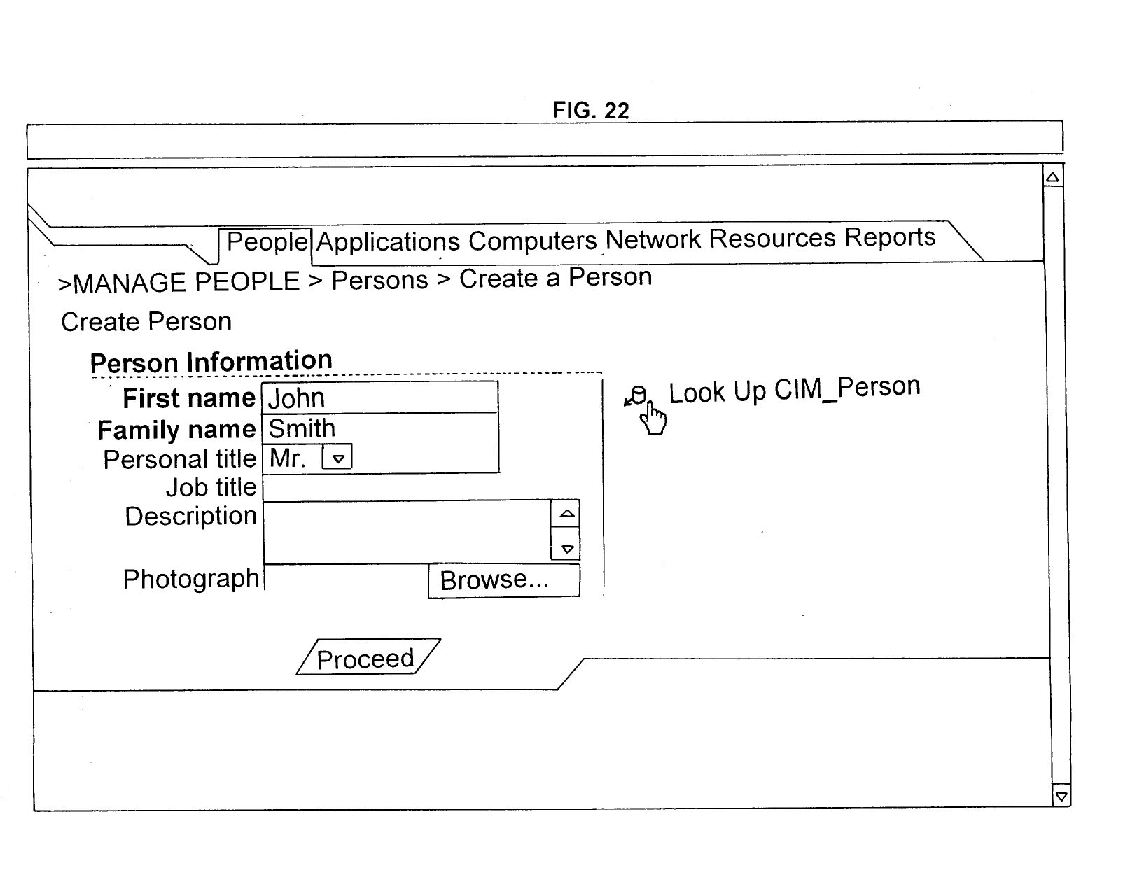

FIGS. 10-22 show some sample XML code that describes a User Interface Procedure, some Fields, the same Fields collected into a Fieldset, a Link and two Views.

FIGS. 2-6 comprise a representation of the high-level relations between the major architecture components according to the invention, showing which components are prepared statically, which are generated automatically and which are used at runtime.

As described in detail below, from the XML Description 1, and one of several UI Skins 2A-C, a full set of Web Page Templates 3A-C are automatically generated. The UI Runtime 4, implemented separately, makes use of the XML Description 1 as well as the Web Page Templates 3A-C.

According to FIGS. 2-6 the invention comprises an additional layer 5 (FIG. 7) onto an ordinary MVC architecture 6 (FIG. 7), this layer provides:

I. An XML vocabulary to logically describe the views, the data content and the behavior of a Web User Interface, i.e. an XML vocabulary to specify a UI Description. The UI Description is what enables the possibility to automate the management of inter-dependencies between the three MVC components.

II. Means to specify how a UI Description is to be rendered in a web browser. This presentation information is encapsulated as a set of XSLT templates plus external client-dependent code. We will use the term UI Skin to refer to each such definition of a presentation. Note that a UI Skin depends also on the templating mechanism adopted by the implementation of the UI Runtime (Controller), e.g. to use ASP and JSP as a templating mechanism (for visually the same presentation) would require two UI Skins, as this would require changes in the UI Skin code (XSL templates, plus client-dependent code).

III. A tool to process the UI Description plus an associated UI Skin definition to generate automatically the views, or web page templates, for the User Interface.

IV. For the preferred embodiment: Implementation of functionality callable at runtime, to take advantage of the UI Description.

The XML Model is an XML vocabulary to logically describe the elements of a Web User Interface, e.g. screens or views, data sets used in forms, links and their parameters, actions, including messages exchanged with the underlying application, procedures that define sequences of screens, etc.

The XML Model is only concerned with the logical aspects of the Web User Interface. All that concerns presentation is handled via a UI Skin, of which there may be as many as desired.

The XML Description of a Web User Interface is used to:

I. To define each screen (View) used by the User Interface; for each UI Skin, a Web Page Template for each view is automatically generated from the XML Description, and is what is used by the Controller to return a view to the user, as response to an HTTP request.

II. To provide information about each view (e.g. template file, dynamic data content, view-specific data values), for the Controller to use during the runtime processing of HTTP requests.

III. To define the flow sequences between Views; this information is used at runtime by the Controller to determine what the next view should be. The Controller is thus reduced to a generic runtime engine, and is itself controlled by the XML description.

IV. To identify view-specific actions and/or data exchanges (data messages between the UI and the Underlying Application of Model) to be performed by the UI Logic (Controller). How these actions are implemented is of course embodiment-dependent.

Better control, as well as increased efficiency in the development and maintenance of the User Interface, is achieved by factoring out into external declarations, each independent from the other, all UI elements that are:

I. either used by more than one of the three MVC implementation components;

II. or are likely subject to need changing frequently.

Or both, of course. For example: sets of data used within a dynamic web page, how dynamic pages are connected to each other into a sequence, the design of the visual presentation.

This independence between definitions of UI elements implies that modification of a single UI element will not break, or effect, any other. The externalisation of each element means no effort is spent to duplicate those that are needed in several places; UI elements are defined once and re-used, by reference, as many times as needed. Re-using elements by reference also guarantees a higher level of consistency.

The separation of presentation, content (data), and the user interface logic that handles the movement of data (messages) between the presentation and the underlying application, is naturally achieved as each of these is defined as separate elements. As for the implementation, there is no constraint imposed on what technology is used to implement each one. Thus, presentation could be in DHTML, WML, . . . , each defined by a UI Skin; the UI Logic could be implemented in a programming language of choice, such as Java or Python; and the data itself can take whatever shape, form or schema it needs.

In addition to the established benefits that such a 3-way separation offers, building a web user interface from a descriptive model adds the significant advantage that changes in the descriptive model are automatically reflected in each of these 3 layers, in the appropriate way for each layer. For example, if the data set used in a user interface procedure (a sequence of dynamic pages) is changed, both the user interface logic (that must handle this data) and the individual dynamic pages (that must collect or present this data) will automatically reflect the change as they both get the information from exactly the same (and unique) source, i.e. the description of the data set. Thus the integration of separately maintained presentation, content and logic is facilitated. The new architecture, indicating how the XML Description of a User Interface imposes and builds on the MVC architecture, is visualized in FIG. 7.

The model 5 (FIGS. 7 and 8) is broken up into a collection of views 6, a collection of procedures 7 that specify the flow of views, a collection of fields 8 and links 9 as the data of a view, and a collection of actions 10, including exchange of messages with the underlying application. The primary relationships between these collections are shown in FIG. 4.

The central concept and element of the model is the View object 6. A view is equivalent to a screen or page. The model offers means to describe what fields are used in a view, how those fields are used by the view (e.g. to show their values, or to ask the user to provide values), what messages are to be exchanged, what presentation design is to be used, and so on.

The model diagram, with the view object as the centre, is shown in FIG. 9. A number of details appear. It can be seen that a View is composed of a Doc 11, a PageInfo 12, one or more PageParts 13, and associated Actions (OnLeave 14, OnArrive 15 specify when these are executed). PageParts 13, are collections of FieldSets 16 (inside of a Form 20), LinkSets 17, as well as arbitrary XFI 18 (Cross-Format Information) that can mix any rendering code (e.g. HTML, JS, CSS) with references to Fields and Links. A Field may have a RegExp 19 (Regular Expression) object associated, which will later be used at runtime to validate input data from a user for this Field. Actions 14, 15 may be associated to a View 6, a Form 20 and Link 9 objects.

All objects are described once, and can be used by reference as many times as necessary.

As explained later the Model also defines the attributes and structure for each of the objects shown in the model diagram of FIG. 9.

A primary design goal of the XML Model is to allow the definition of UI Components once, and to be able to use defined components to define other components. A UI Component could be anything from a Link, a Field, pre-defined sets of these, Actions, PageParts, entire Views, Procedures, as well as arbitrary logical presentational XFI elements such as dividers, presentational containers, sections with contextual navigation or options, data representation templates, and so on.

In general, the Link and Field elements are the building blocks of a UI Description. Linksets and Fieldsets are a collection of references to Links and Fields respectively.

PageParts are composed of references to Links and Linksets, Fields and Fieldsets (within a Form), as well as references to XFI elements when needed.

When re-using element definitions by reference, a certain amount of flexibility is allowed: All attributes allowed on the element definition may be overridden each time the element is used by reference from another element. For example, the Field CIM_Person_GivenName may be defined as follows:

<field key=“CIM_Person_GivenName” label=“First Name” required=“false”>

<devdesc>The Given Name property is used for the part of a person's name

that is not their surname nor their middle name.</devdesc>

<uitype widget=“string” data=“string”/>
<mapping model=“CIM” class=“CIM_Person” property=“GivenName”

list=“true” type=“string”/>

</field>

This field definition specifies that by default this field is not required to be filled (required=“false”) when used within a View. However, individual references to this field may override this default, as in the following example, in which the above field definition is referenced from within a View.

<view key=“CreatePerson”>

<pagepart shellhook=“main”>

<form action=“/spms/CreateObject”>

<xfi key=“formSection”>

<field key=“CIM_Person_GivenName” action=“get” required=“true”/>
<field key=“CIM_Person_Surname” action=“get” required=“true”/>
<field key=“CIM_Person_PersonalTitle” action=“get”/>

</xfi>
<submit textlabel=“Proceed” userdesc=“Proceed to create person”/>

</form>

</pagepart>

</view>

The generation of the Web Page Template for this View, as well as the Runtime processing of this View, can in this way treat this field as required for this form only, e.g. the Web Page Template could show the label of this field in bold, and the runtime processing could refuse this form to be submitted unless a valid value is specified for this field.

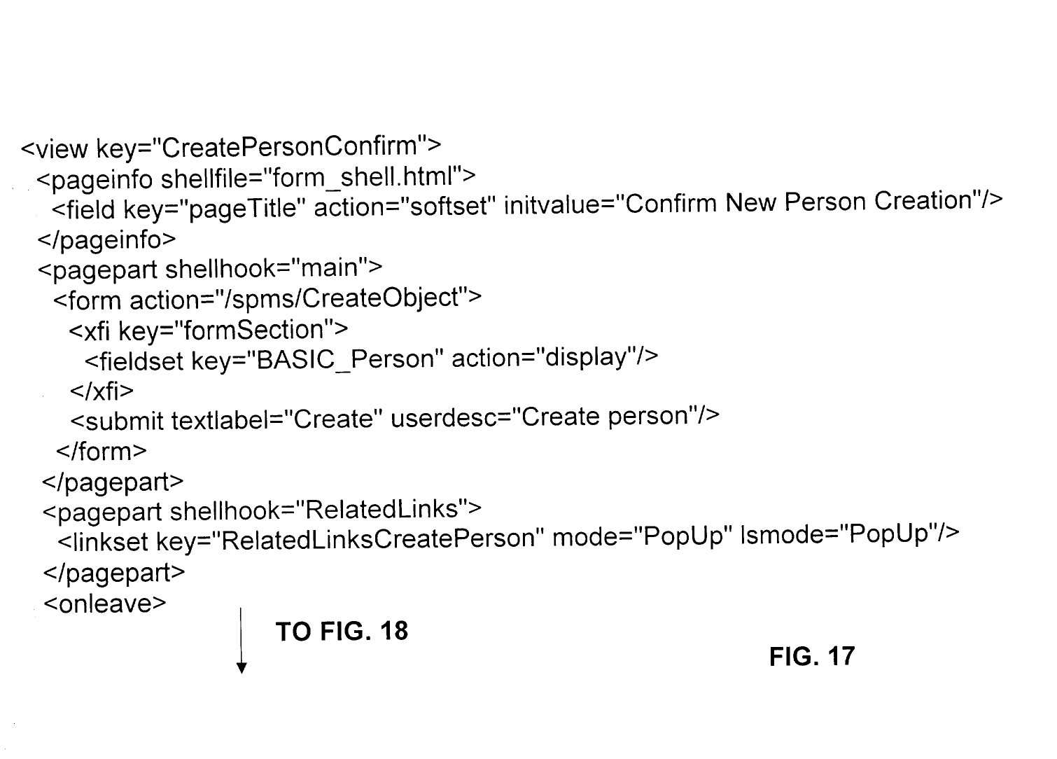

Notice also the action attribute on field references. This will determine how the field is used by this view and will cause the generation of the appropriate Web Page Template code for this field, e.g. whether a value for this field is to be obtained from the user or whether the value for this field is to be displayed to the user. An illustration of this point is also provided by the FIGS. 17-19 and 20-22.

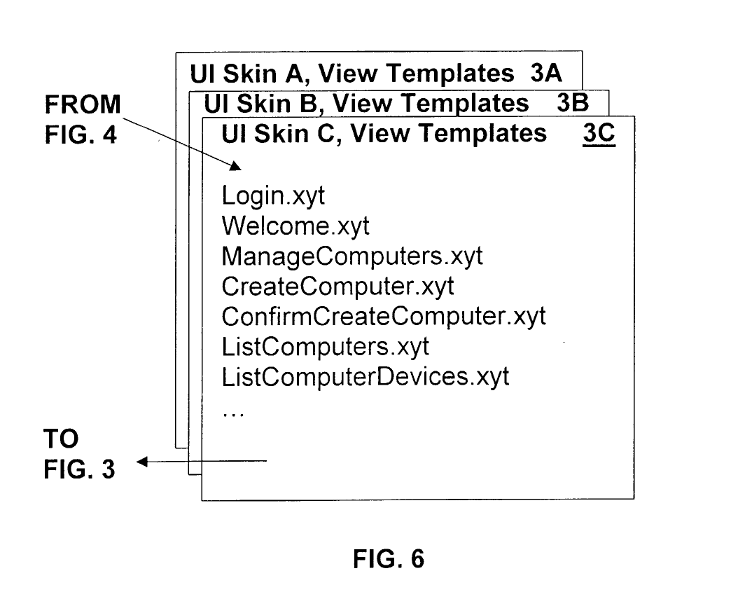

As mentioned above, relating objects and properties of a hierarchical Data Model to the flat-list world of Web form fields is a problem for web-based User Interfaces. The UI XML Model addresses this issue by specifying a mapping between each data field used by the Web Interface, and the Data Model (or Models) used by the underlying application. FIG. 6 offers some examples of such data field mappings, for the particular case when the underlying Data Model is the CIM (Common Information Model from the DMTF: http://www.dmtf.org/).

For each embodiment of the User Interface Runtime, callable functionality will use this information to map HTTP input data and data to be exchanged with the underlying application, and vice-versa.

User Interface Customizations are handled via a mechanism similar to that of CSS (Cascading Style Sheets). The main collection elements of the XML Model, namely Views, Procedures, Fields, Links, and Actions may inherit from another collection of the same type. Thus, the collection inheriting from another collection may specify only those elements (or parts thereof) that need to be customized. The XML providing the differences required by the customization is processed in along with the reference XML Description being inherited from, and a fully resolved version of the customized UI XML Description is produced. I.e. each customized sub-element in the collection will be merged with the corresponding sub-element (identified by the element key attribute) in the referenced collection. Elements added in the customizations will simply be added to the resolved customized UI Description. Elements not customized in the reference UI Description will be inherited as is by the customized UI Description. All other processing from this point on, namely generation of Web Page Templates and support for the User Interface Runtime, is the same.

Support for different languages is treated simply as a customization, thus handled as described above.

A UI Skin defines a presentation of a Web User Interface Description. A Skin consists of a collection of XSL Templates, that define the Web Page Template code to be generated for each element type, as well as a collection of external files required by this presentation. The external files consist of a collection of shell templates, plus any required linkable material such as external Cascading Style Sheets (CSS), JavaScript functions (JS), and images.

A shell template defines the general Web Page Layout for a View. Web Page Templates that follow a similar general Page layout use the same shell template, or stated differently, a shell template is needed for each category of Web Page Templates used by the User Interface.

The collection of XSL Templates generate the Web Page Template code for each PagePart, depending on the key settings of the elements contained in the PagePart. For example, for the Field element, the key settings that determine which XSL template is called are action attribute and uitype sub-element. Additionally, special use XSL templates may be defined and related to elements by the use of a mode attribute on the element.

Each View is associated with a shell template (shellfile attribute on pageinfo), and each PagePart in the View is associated with a placeholder in shell template (shellhook attribute on pagepart). The generation process will first generate the Template code for each Pagepart, and then assemble full View templates by combining a shell template and the generated PageParts.

An example of what is described above are the sample XML and sample views of FIGS. 10-16, 17-19 and 20-22.

As outlined in previous paragraph, Web Page Templates are generated automatically by combining the generated code for each PagePart of a View, and the shell template associated to that View.

PageParts are composed of a combination of the elements form, xfi, field, fieldset, link and linkset. The elements field and fieldset may only occur inside a form element. Xfi elements may contain any of the these other elements, as well as be nested.

For each UI Skin, conversion of these elements are handled by means of a set of XSL Transformation (XSLT) templates. For each source XML element, the value of some key attributes determine which XSLT template is called during conversion. The first phase of the conversion is a generic preparation phase, where each XML element in a PagePart is first processed to resolve references, and passed via special dispatching XSLT templates that then call the XSLT templates for the current UI Skin. However, no output is written during this preparation phase; all output is left for the XSLT templates. To simplify the task for the UI Skin developer, the XSLT templates that generate the final web page template code are given a fully worked out node-set as a parameter. In this way, the transformation that the UI Skin developer must specify is nothing more than a straightforward writing-out, or dump, of the node-set to the target web page template code.

For usage variations for otherwise identical elements, all elements may specify a mode attribute. The UI Skin developer must supply a corresponding output XSLT template for each mode employed.

For example, a form element, with no mode specified, will be converted using a XSLT template named form-default, while if a mode attribute is specified then a template with the name of form-modevalue will be called (the responsibility to define it belongs to the UI Skin developer).

Xfi's, due to their already custom nature, have no modes. Any number of arbitrary parameters may be defined on an xfi element by simply adding attributes on the xfi element. Xfi elements are identified by the value of their key attribute (thus a XSL template called xfi-keyvalue will be called to generate the Web Page template code for the xfi).

Fields and links are treated differently, due to the variety of usage scenarios for these elements.

Fields have four pre-defined usage possibilities (softest, display, get, remember), and may be presented to the web user by means of one of eight pre-defined widgets (string, textarea, select, password, radio, checkbox, image, file). When a field element is encountered (as a reference inside a PagePart, or as a reference inside of a fieldset referenced from within a PagePart) then the XSLT template to call is identified by the value of the field's action attribute, and the value of its uitype widget attribute. Thus names for output templates for fields are constructed as follows: field-widgetvalue-actionvalue. Additionally, a mode may be specified, as for the form element.

Furthermore, to make the use of fieldsets as versatile as possible, a fieldset reference within a PagePart may specify any field attribute, which is then passed down onto each field reference in the fieldset during the element preparation phase. As an example, note the use of the action attributes in the fieldset used by the views shown in FIGS. 7 and 8.

The link and linkset elements are handled similarly to field and fieldset, except that for link it is the value of the type attribute (internal or external) that determines which XSLT template is to be called. Again, a mode attributes may be specified. As an example, let's take a look at the XSLT templates that generate the output code for the field CIM_Person_GivenName, used in FIGS. 10-16, 17-19 and 20-22. Note that each of the views in FIGS. 7 and 8 make use of the fieldset BASIC_Person. The definition for this fieldset is provided in FIGS. 10-16. During the element preparation phase, the BASIC_Person reference within each view is expanded, first to identify the list of field references contained, then to merge each field reference with the corresponding field definition (example definitions are shown in FIGS. 10-16). In the process, any field attribute found on fieldset (in this case the action attribute) is passed down to each fully worked outfield node-set. Thus, two different XSLT templates are called to convert this field, one in the case when action-“get” (view CreatePerson) and the other in the case of action-“display” (view CreatePersonConfirm). In both cases, the UI widget type is string.

An example of the XSLT template for when action is get could be:

<xsl:template name=“field-string-get”>

<xsl:param name=“fieldNode”/>
<tr>

<th class=“{$fieldNode/xtras/@cssClass}”>

<xsl:value-of select=“$fieldNode/@label”/>

</th>
<td class=“border_right”>

<input type=“text” name=“{@key}”

value=“{$fieldNode/xtras/@templateExpression}”
class=“input_text” size=“{$fieldNode/xtras/@size}”/>

<xsl:if test=“$fieldNode/@userdesc”>

<xsl:call-template name=“write-field-userdesc”>

<xsl:with-param name=“userDesc” select=“$fieldNode/@userdesc”/>

</xsl:call-template>

</xsl:if>

</td>

</tr>

</xsl:template>

When action is display, the output XSLT template could be:

<xsl:template name=“field-string-display”>

<xsl:param name=“fieldNode”/>
<tr>

<th class=“{$fieldNode/xtras/@cssClass}_display”>

<xsl:value-of select=“$fieldNode/@label”/>

</th>
<td class=“field_display”>

<input type=“hidden” name=“{@key}”

value=“{$fieldNode/xtras/@templateExpression}”/>

<span class=“{$fieldNode/uitype/@widget}”>

<xsl:value-of select=“$fieldNode/xtras/@templateExpression”/>

</span>

</td>

</tr>

</xsl:template>

The xtras sub-element of the node-set parameter $fieldNode is an addition of the element preparation phase, to simplify the development of the XSLT templates of a UI Skin; the xtras element contains prepared information that may be useful when converting the element to Web Page Template code. Shown in this example are the xtras attributes templateExpression and size, thus prepared for the developer's convenience. The xsl:call-template to template write-field-userdesc (template itself is not shown here) writes out the template code necessary to display the text value of the userdesc attribute if one is specified (similar to the link example of FIGS. 10-16, with the help text being displayed on mouse over the link image, shown in FIGS. 17-19).

The output of the above two XSLT templates, for the example field CIM_person_GivenName, are:

Output from field-string-get XSLT Template:

<tr>

<th class=“fieldRequired”>First name</th>
<td class=“border_right”>

<input type=“text” name=“CIM_Person_GivenName”

value=“${CIM_Person_GivenName}” class=“input_text” size=“30”/>

</td>

</tr>

Output from field-string-display XSLT Template:

<tr>

<th class=“fieldRequired_display”>First name</th>
<td class=“field_display”>

<input type=“hidden” name=“CIM_Person_GivenName”

value=“${CIM_Person_GivenName}”/>

<span class=“string”>${CIM_Person_GivenName}</span>

</td>

</tr>

A web browser will render this piece of template code at runtime, as indicated by the two full web pages that are shown in FIGS. 17-19 and 20-22.

The XML examples of FIGS. 10-16, 17-19 and 20-22 include other elements, such as the two xfi elements, formSectionLookUp and formSection. These are converted using XSLT templates similar to the example above, for the field CIM_Person_GivenName, to give the visual output shown in the web pages of FIGS. 17-19 and 20-22.

The User Interface XML Description is also made accessible to the User Interface Runtime (the Controller for the MVC paradigm). The advantages this provides for the Runtime may be broken into two primary categories:

I. Support for generic handling of requests, driven by the XML Description, the meta information about each web page, or view, and its contents may be used to systematically set-up the HTTP response. This behavior of the UI Runtime is transparent, i.e. it is not explicitly declared as actions in the XML description, but is performed automatically.

II. The possibility to have the XML Description include explicit declarations to execute special actions at specific times, namely when loading or unloading a web page, or when submitting a form, or when following a link. A single generic Runtime controller may therefore act as the handler for many dynamic web pages, thus significantly reducing the amount of handler code required for the User Interface.

All the User Interface Runtime support functionality described here may be achieved in several ways and several technologies, and is implementation-dependent. Thus, the Runtime can be built in Java, Python or other programming languages, but the Runtime functionalities described below are required to be implemented per implementation technology.

To achieve the above, the Runtime needs to be passed some minimum pieces of control information with each HTTP request. The control info serves to identify what view the request is originating from, what form has been submitted, or what link the web user has clicked on to generate the HTTP request. In addition, if the HTTP request is within a defined procedure sequence, a procedure identifier is also passed as parameter to the Runtime.

Having thus received this minimal control information, the Runtime is able to identify and retrieve the XML descriptions for the objects involved in each HTTP request, i.e. views, forms, links, procedures and actions. From these objects, the UI Runtime can then freely navigate the rest of the User Interface Description to obtain any other information that it needs to perform the above-mentioned generic handling of requests.

Common and repetitive chores to be performed by the Runtime with each HTTP request may be entirely automated. Information that the Runtime needs to access, or functionality to be implemented that uses this information, includes:

I. The descriptions for the source View, source Form, source Link, and/or current Procedure.

II. The list of fields, and initial values if any, used by the source View or the source Form.

III. The allowed data type for each input field in the request HTTP data (flat list of name/value pairs). This could be a pre-defined type (such as string, integer, jpegfile, etc.), as well as be supplemented with an arbitrary regular expression. Input data checking may be handled centrally and transparently for all requests, by systematically checking input field values against allowed data types as specified in the description for each input Field.

IV. Determination of the next view, or the view to be returned as response for a request. In the simple case, such as that when the user follows a link, the next view may be determined by accessing the information contained in the link object. In more complicated cases, such as when the user submits a form from a page within a procedure, the next view is determined by processing the conditions specified in the procedure object (see FIGS. 10-16 for a sample procedure and test conditions).

V. The description for the next View, including:

a) The file name of the Web Page Template to use for the HTTP response.

b) The list of fields used by the next view which can therefore be prepared with the appropriate values.

VI. Transparent updating of additional view-specific navigation and orientation cues, used by the presentation templates to help the web user accomplish tasks. Examples of such information, extracted from the XML Description, are:

a) The number of steps in a procedure, with highlighting of the current step (see FIGS. 10-16, 17-19 and 20-22).

b) The breadcrumb trail, to help orient the web user, by indicating the logical path to the current location (see Web Pages in FIGS. 17-19 and 20-22).

Custom actions are typically handled by custom handlers. While the framework described by this invention also allows for this scenario, it also allows for the encapsulation of functionality needed by custom handlers, and then to declare and associate any custom actions to a view, form or link. This feature can therefore reduce, or remove altogether, the need to develop and maintain custom handlers. The Runtime will execute custom actions declared in the XML as necessary.

Support for custom actions may be divided into commonly needed basic functionality, and specialized actions that make use of this basic functionality. The XML Description need only include declarations of specialized actions.

Commonly needed functionality to support custom actions includes:

I. Automation of the mapping of input field data to object instances of the Data Model used by the underlying application, for any data exchanges between the User Interface and the underlying application. This functionality provides the mapping of the flat-list world of Web form fields, and the typically hierarchical Data Models (e.g. a description of the tables of a database) used by underlying application.

II. Automation of the mapping of properties of object instances received from the underlying application to User Interface field name/value pairs used by the Web Page Templates.

Custom actions are obviously dependent on the specific User Interface application, and thus could be anything. However, custom actions may be identified and encapsulated into callable functions.

How XML action declarations are mapped to a call to a specific function, with the appropriate parameters and with the appropriate output depends on the particular embodiment.

For example, in the case when the underlying application uses the Common Information Model (CIM) as interface, a CIM transaction may be abstracted to XML declarations. Examples of CIM transactions are the preparation of requests and the processing of responses for CIM queries such GetClass, GetInstance, ModifyInstance, EnumerateInstances, AssociatorNames, etc. For reference information about CIM see:

http://www.dmtf.org/standards/standard_wbem.php

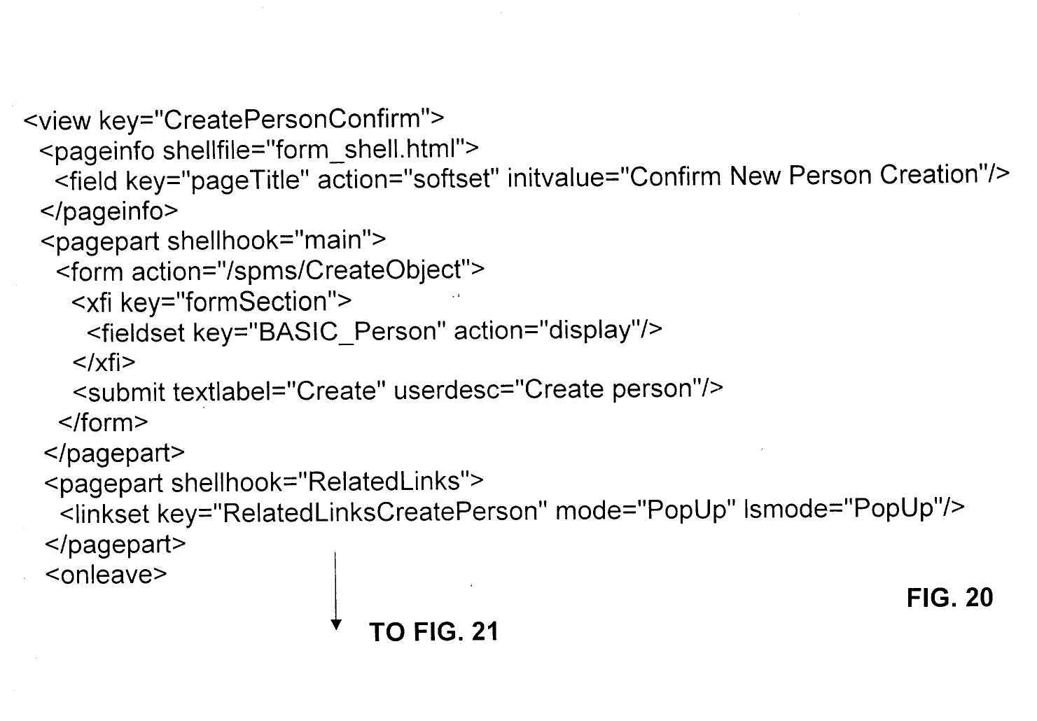

FIGS. 17-19 and 20-22 indicate how actions can be declared in the XML Description, including in FIGS. 20-22, how the output parameters of one action can be used as input to another, thus allowing sequencing of actions that may depend on the result of previously executed actions. The logic that is executed for any single action is to be implemented as additional functionality to the UI Runtime, and in such a way that the UI Runtime is able to read the XML action declarations and parameters, and execute the correct functionality.

The following specification is divided into the collections of the XML Model, as identified in FIG. 8.

The syntax used below to specify the XML elements comprising the XML Model is non-standard, but is somewhat DTD-like syntax and, in the opinion of the author, is simpler and more visually informative. Here are the guidelines to interpret the syntax:

a) Structure is indicated by the nesting of XML Elements names.

b) For each XML element, allowed attributes are listed on the element's open tag. Allowed values for each attribute are indicated as either a primitive type (e.g. string, integer), or a value in a pre-defined list (possible values enclosed in parentheses) with the default value appearing after a “:” character, or as a value defined elsewhere in the XML Description indicated with an XPath expression (enclosed in curly brackets).

c) Allowed content is indicated with an XML comment that starts with either “content” or, when content is allowed in any order, with “unordered content”. This is followed by a list of element names or groups, in parenthesis, where special characters (*, ?, . . . ) that follow elements or groups of elements have the same meaning as in a DTD, or with “#text” for when content allowed is text.

d) Each element (within a context) is defined in full only once. If an element is listed in the allowed content list of elements, but no definition is provided, then the closest definition of the same element is assumed.

e) Some elements are sometimes “references” and sometimes “definitions”; namely the elements view (definition when within views, reference when within procedure), field & fieldset (definition when within fields, reference elsewhere), link & linkset (definition when within links, references elsewhere).

f) Text on a line that follows “--” (2 hyphen characters surrounded by white space) is a comment.

[image]

[image]

[image]

[image]

[image]

[image]

[image]

[image]

Finally it should be noted that the aforedescribed embodiments of the method and system are provided by way of non limiting example, numerous modifications being possible all falling within the same inventive concept, for example the XML model could be developed using other data definition language, and or it could interact in a different way with the MVC components.

1) Method for developing and managing large-scale web user interfaces (WUI), comprising:
designing and implementing the WUI using the Model View Controller (MVC) paradigm,
characterized in that it comprises:
adding an additional layer (5) to the MVC paradigm,
said additional layer (5) comprising a UI description (1),
said UI description comprising all UI elements that are used by at least one of the MVC implementations components, such as views, descriptions of content data, and the behavior of the WUI.

2) Method according to claim 1 characterized in that the additional layer is an XML model (5).

3) Method according to claim 1 characterized in that the additional layer (5) imposes on the MVC components.

4) Method according to claim 3 characterized in that the additional layer (5) imposes on the MVC presentation layer (6A).

5) Method according to claim 4 characterized in that the additional layer imposes on the MVC presentation layer (6A) of a 3-tier web application (6).

6) Method according to claim 1 characterized in that the UI description (1) is only concerned with the logical aspects of the web UI.

7) Method according to claim 1 characterized in that each UI element is independent from the other.

8) Method according to claim 1 characterized in that UI elements are defined once and may be re-used, by reference, to compose other UI elements contained in the same UI description (1).

9) Method according to claim 1 characterized by associating to a UI description (1) a UI skin (2A-C), each said UI skin specifying one way of how the UI description is to be rendered in a web browser.

10) Method according to claim 9 characterized in that the UI skin (2A-C) comprise a collection of XSL templates that define web page template code to be generated for each element type, and a collection of external target client dependent files required by this presentation.

11) Method according to claim 10 characterized in that the external files comprise:
shell templates, plus any required linkable material, such as external cascading style sheets, client-side JavaScript code and other graphical elements such as images, said shell template defining the general web page layout for a view, for each category of web pages used by the UI.

12) Method according to claim 10 characterized in all presentational dependencies on the templating mechanism adopted by the implementation of the UI Runtime are constrained to the UI Skin associated to the UI Description.

13) Method according to claim 1 and 9 characterized by processing the UI Description (1) and an associated UI Skin (2A-C) to generate automatically the view, or web page, templates for the UI.

14) Method according to claim 1 characterized in that the presentation of all UI elements is controlled by client dependent rendering code.

15) Method according to claim 1 characterized in that web page templates used by the UI runtime are automatically generated from the UI description (1) and the client dependent rendering code.

16) Method according to claim 1 characterized in that the implementation of the UI runtime logic also uses the UI description (1) to determine both:
meta-information needed for each screen, or web page,
as well as the conditional flow from screen to screen.

17) Method according to claim 1 characterized in that the additional layer (5) comprises a plurality of UI components, first components being view objects (6), each view being equivalent to a screen or page.

18) Method according to claim 17 characterized in that each view object (6) is connected to other UI components comprising:
a plurality of procedure objects (7) that specify the flow of views required for the accomplishment of a UI task,
a plurality of field (8) and link (9) objects that define the content data used by the related view object (6),
and a plurality of action objects that define the actions that the controller should perform.

19) Method according to claim 17 characterized in that each view object (6) is connected to a doc (11), a pageinfo (12), at least one pagepart (13), and associated action objects which specify actions to be executed and when,
said doc (11) contains developer and user documentation for the view,
said pageinfo (12) specifies information about the page namely which shell or custom template is to be used for this view and the collection of fields used by the shell or custom template,
said pageparts (13) are collections of fields and fieldsets (16) inside a form object (20), links and linksets (17), as well arbitrary cross format information XFI objects that can mix each rendering code with references to fields and links,
said fieldsets and linksets being a collection of references to links and fields respectively,
that a field may have a regexp object (19) associated which may be used at runtime to validate input data from a user of this field.

20) Method according to claim 18 characterised in that actions are associated to a view (6), form (20) and link (19) objects.

21) Method according to claim 17, 18 and 19 characterised in that objects are described once and can be used by reference as many time as necessary to define other UI components, such as use of link and field definitions to define fieldsets, linksets, pageparts and views, re-use of arbitrary logical presentational XFI elements such as dividers, presentational containers, sections with contextual navigation or options, data representation templates, to define pageparts, use of pageparts to define views, re-use of pageparts across views, and re-use of views in different procedures.

22) Method according to claim 1 characterised by comprising a mapping between each data field used by the WUI and the Data Model or Data Models used by the underlying application.

23) Method according to claim 18 characterised in that in order to obtain a UI customisation, the views (6), procedures (7), fields (8), links and (9) actions of the additional layer (5) may inherit from another collection of the same type, thus collection inheriting from another collection may specify only those elements or parts thereof that need to be customised.

24) Method according to claim 23 characterised in that the minimal (delta) XML Description that specifies only customized elements, plus a reference XML Description being customized, are processed to produce a fully resolved and complete version of the customized UI XML Description.

25) Method according to claim 10 and 19 characterised that the collection of XSL templates generate the web page template code for each pagepart, that an XSL template is selected and parametrised by way of attribute values of the elements contained in the pagepart (13),
that each view (6) is associated with a shell template by a shellfile attribute on the pageinfo (12) element, and each pagepart (13) in the view (6) is associated to a placeholder in the associated shell template by a shellhook attribute on the pagepart,
that the generation process first generates the web page template code for each pagepart (13), and then generates web page templates by combining the generated code for each pagepart of a view (6) and the shell template associated to that view.

26) Method according to claim 25 characterised in that the UI description (1) include explicit declarations to execute special actions at specific times.

27) Method according to claim 25 characterised in that an HTTP request handled by the UI Runtime comprises pieces of control information which enables the Runtime to identify and retrieve the UI description for the objects involved in each HTTP request.

28) Method according to claim 26 characterised in that the explicit declarations to execute special actions at specific times comprises custom actions.

29) Method according to claim 28 characterised in that for the special or custom actions the logic that is executed for any single action is to be implemented as additional functionality to the UI Runtime, and in such a way that the UI Runtime is able to read the XML action declarations and parameters, and execute the correct functionality.

30) Method according to claim 28 characterised in that the custom actions are implemented as callable functions.

31) Method according to claim 1 characterised by relating descriptions of properties of an Application Data Model with additional information required by the User Interface, such as human labels and descriptions for a given property and how a given property is to be handled presentationally.

32) Method according to claim 1 characterised in that the UI flow is described in XML procedures, wading through UI logic code to understand said flow being no longer necessary.

33) Method according to claim 1 characterised by automatic validation of input data taking into account constraints imposed by the Presentation and constraints imposed by the Underlying Application.

34) A computing system for a large scale WUI developed according to the method of any of the claims 1 to 33, comprising:
a memory for storing said WUI,
and means for processing the UI description to automatically generate the Views, or
web page templates for the UI.

35) Computing system according to claim 34 characterised in that it comprises:
means for accepting an HTTP request,
means for processing this request comprising:
means for reading the UI description (1),
means for exchanging data between the MVC components (6) with mapping as specified in the UI description (1), data exchange between the Views and the Model or Underlying Application being performed by the Controller according to the mappings specified in the UI description.

36) Computing system according to claim 34 characterised in that it comprises means for generating automatically the web page templates used by the UI runtime from the UI description and the client dependent rendering code.

37) Computing system according to claim 34 characterised in that it comprises means for creating a mapping between each data field used by the WUI and the Data Model or models used by the underlying application.

38) Computing system according to claim 34 characterised in that it comprises means for processing the minimal (delta) XML Description that specifies only customized elements, plus a reference XML Description being customized to produce a fully resolved and complete version of the customized UI XML Description.

39) Computing system according to claim 34 characterised in that it comprises means for automatically accessing the UI description (1) of the additional layer (5) to the MVC paradigm (6) to the controller of the presentation layer, i.e. the UI Runtime.

40) Computing system according to claim 34 characterised in that it comprises means for executing special actions at specific times, said actions having input and output parameters, and time when they are to be executed, being specified in the UI description (1).

41) Computing system according to claim 34 characterised in that it comprises Runtime means for handling a HTTP request, said request comprising pieces of control information which enables the Runtime means to identify and retrieve the UI description (1) for the objects involved in each HTTP request.

42) A web server for a large scale WUI developed according to the method of any of the claims 1 to 33 comprising a computing system according to claims 34-41.

43) A computer program comprising program instructions for causing a computer to perform the method of any of the claims 1 to 33.

44) A computer program according to claim 43 stored in a computer memory or embodied on a record medium or in a read only memory or carried on an electrical carrier signal.
